(19) United States
(12) Patent Application Publication
(10) Pub. No.: US 2020/0032887 A1
(43) Pub. Date: Jan. 30, 2020

(54) METHOD OF MANUFACTURING AN IMPELLER HUB

(71) Applicant: SCHAEFFLER TECHNOLOGIES AG & CO. KG, HERZOGENAURACH (DE)

(72) Inventors: Craig MCBURNEY, Wooster, OH (US); Jose Vazquez VALDEZ, Wooster, OH (US)

(21) Appl. No.: 16/046,311

(22) Filed: Jul. 26, 2018

(51) Int. Cl. F16H 41/28

(52) U.S. Cl. CPC F16H 41/28; B23K 2101/001

(57) ABSTRACT

A torque converter that includes an impeller hub with an elongated member portion including a beveled-surface running radially and axially outward from an impeller assembly from a first end in contact with an impeller assembly to a second end, wherein the impeller hub further includes a weld at the beveled-surface and in contact with the impeller assembly.

### TECHNICAL FIELD

The present disclosure relates generally to torque converters and more specifically to methods of joining impeller hubs to torque converters.

### BACKGROUND

The present disclosure relates generally to torque converters and more specifically to methods of forming impeller hubs of torque converters. Durability of a pump weld may need to be increased based on the dimensions of the material welded. There may be a need to increase the capacity of a weld without using additional space for the weld or changing any tooling.

### SUMMARY

According to a first embodiment, a torque converter, includes an impeller hub, wherein the impeller hub includes an elongated member portion including a beveled-surface running radially and axially outward from an impeller assembly from a first end in contact with an impeller assembly to a second end, wherein the impeller hub further includes a weld at the beveled-surface and in contact with the impeller assembly.

According to a second embodiment, a method of attaching an impeller hub of a torque converter to an impeller shell comprises beveling the impeller hub, wherein the impeller hub is beveled to form a beveled-surface extending from a first end to a second end, and welding the impeller hub to the impeller shell, wherein the welding creates a weld in contact with the shell, and the first and second end of the beveled-surface.

According to a third embodiment, an impeller hub comprises an elongated member portion including an inner surface having a first end configured to be in contact with an impeller assembly, wherein the elongated member portion further includes an outer surface having a second end configured to not be in contact with the impeller assembly, and a beveled-surface configured to extend axially and radially outward from the impeller assembly from the first end of the inner surface to the second end of the outer surface.

### BRIEF DESCRIPTION OF THE DRAWINGS

FIG. 1 is a cross-sectional view of a torque converter having an impeller hub welded to an impeller shell; and

FIG. 2 is a cross-sectional view of the impeller hub with a bevel welded to the impeller.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

At the outset, it should be appreciated that like drawing numbers on different drawing views identify identical, or functionally similar, structural elements of the disclosure. While the present disclosure is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims. It is also understood that any reference to axial, radial, or circumferential directions, surfaces, or properties is made with respect to the axis of rotation shown in the drawings, indicated generally as axis A. Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

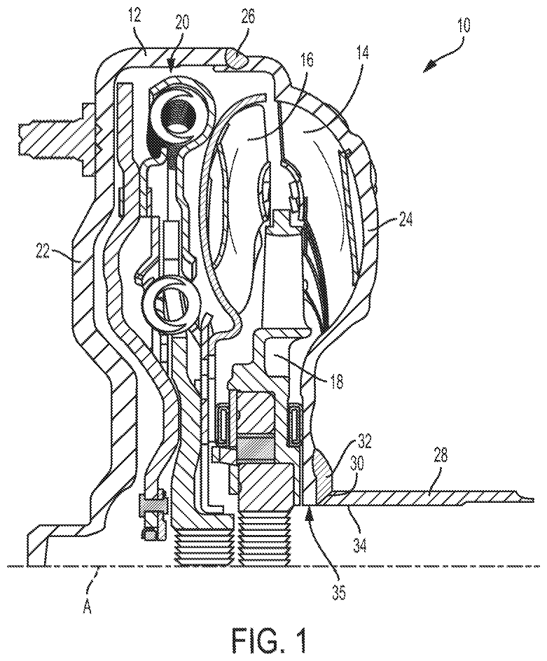

FIG. 1 is a cross-sectional view of a torque converter having an impeller hub welded to an impeller shell. FIG. 1 shows torque converter 10 arranged, for example, with cover 12 connected to an engine or other torsional input (not shown), the torque converter also having impeller 14, turbine 16, stator 18, and vibration damper 20 for hydraulically transferring torque through the torque converter. These components are shown for purposes of discussion, and could be replaced by any type or style of cover, impeller, turbine, stator, and/or vibration damper known in the art, and in some embodiments, some of these components may not even be included. The torque converter may be a three-pass torque converter, a four-pass torque converter, or any other type of torque converter.

Cover 12 is formed by two cover portions, namely, engine side cover portion 22 and impeller shell portion 24. That is, impeller shell portion 24 also forms a shell for impeller 14. Engine-side cover portion 22 and impeller shell 24 are connected together, such as via cover weld 26. Impeller hub 28, which includes a bevel 30, is affixed to impeller shell 24 via weld 32. In the embodiment of FIG. 1, the bevel 30 may be engaged against the outer radial surface of impeller shell 24 via weld 32, such that inner circumferential surface 34 of hub 28 is aligned with inner circumferential surface 35 of impeller shell 24 for forming a substantially smooth opening for receiving input and/or stator shafts from a transmission for coupling with the output of damper 20 and stator 18, for example.

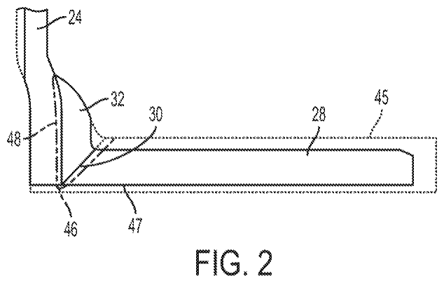

FIG. 2 is a cross-sectional view of the impeller hub with a bevel welded to the impeller. As shown in FIG. 2, the impeller hub 28 may include a bevel 30. The bevel 30 may have an outward most extending point that may be in contact with the impeller shell 24. The bevel 30 may run from the outward most extending point to a second point that is diagonally (e.g. both axially and radially) outward from the impeller assembly. The bevel 30 may include a first end that is on an inner surface (e.g. inner diameter or OD) of the impeller hub 28. The bevel 30 may extend radially and axially away from the impeller shell 24 to a second end of the bevel 30 that is on an outer surface (e.g. outer diameter or OD) of the impeller hub 28. The first end and the second end of the bevel 30 may not be axially aligned. The bevel 30 may be added in the manufacturing process by machining the bevel or chamfering a traditional impeller hub, which may just be a flat surface that abuts with the impeller shell. The bevel 30 may be sized in such a way that in the raw state 45 of material, the root 46 of the weld 32 is outside of an area that will remain after machining without blowing through the joint after taking into account the penetration of the weld into the parent material 48. As shown in FIG. 2, the bevel 30 may run further out based on the raw state 45 of the impeller hub that is shown via dotted lines. Thus, the bevel 30 of the original impeller hub 28 is shown via both solid lines and dotted lines in FIG. 2.

After the bevel 30 is added to the impeller hub 28, the impeller hub 28 may be welded to the impeller shell 24. The weld 32 is added to attach the impeller hub 28 to the impeller shell 24. The weld 32 may run across the entire surface of the bevel 30. Upon the welding process being completed, the weld 32 may create a root weld 46. The root weld 46 may be located in a vicinity of where a point of the bevel 30 is in contact with the impeller shell 24. The weld 32 may be in contact with the parent material 48 of the impeller shell 24.

Upon completion of the welding process, the next step may be to machine-off the root 46 of the weld 32 at the inner diameter of the impeller hub 28 and impeller shell 24. As shown in FIG. 2, the raw state 45 of the impeller hub may include additional surface area, including the root weld 46. The manufacturing process may employ a step to machine off areas of the raw state 45 of the impeller shell 24 and impeller hub 28 such that the root weld 46 is removed. After the machining of a portion of material of the raw state 45, the open root 46 may be eliminated. The increase in the bevel size and penetration depth, the open root 46 of weld 32 is moved into an area that is machined. As such, it eliminates a thin cross-section for a fracture or crack to propagate through. As shown in FIG. 2, once the machining is done, the impeller hub 28 and impeller shell 24, and weld 32 are finally shown in solid lines.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### PARTS LIST

torque converter 10

12 cover

14 impeller

16 turbine

18 stator

20 vibration damper

22 engine-side cover portion

24 impeller shell

26 cover weld

28 impeller hub

30 bevel

32 weld

34 inner circumferential surface

35 inner circumferential surface

45 raw state of material

46 open root

47 machined area

48 parent material

The above is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

What is claimed is:

1. A torque converter, comprising:
an impeller hub, wherein the impeller hub includes an elongated member portion including a beveled-surface running radially and axially outward from an impeller assembly from a first end in contact with an impeller assembly to a second end, wherein the impeller hub further includes a weld at the beveled-surface and in contact with the impeller assembly.

2. The torque converter of claim 1, wherein the weld does not include an open root.

3. The torque converter of claim 1, wherein the weld is in contact with both the first end and the second end of the beveled-surface.

4. The torque converter of claim 1, wherein the first end and the second end of the beveled-surface are not axially aligned with one another.

5. The torque converter of claim 1, wherein the elongated member portion includes an inner diameter surface extending axially away from the impeller assembly.

6. The torque converter of claim 1, wherein the elongated member portion includes an outer diameter surface extending axially away from the impeller assembly.

7. A method of attaching an impeller hub of a torque converter to an impeller shell, comprising:
beveling the impeller hub, wherein the impeller hub is beveled to form a beveled-surface extending from a first end to a second end; and
welding the impeller hub to the impeller shell, wherein the welding creates a weld in contact with the impeller shell, and the first and second end of the beveled-surface.

8. The method of claim 7 wherein the method includes the step of removing a root of the weld at an inner diameter of the impeller shell.

9. The method of claim 8, wherein the removing includes machining-off the root of the weld.

10. The method of claim 7, wherein the torque converter is a three-pass torque converter.

11. The method of claim 7, wherein the method includes the step of machining an elongated member portion of the impeller hub.

12. The method of claim 7, wherein the weld is in contact with an impeller-surface and the beveled-surface.

13. The method of claim 7, wherein the first end and the second end of the beveled-surface are not axially aligned with one another.

14. The method of claim 7, wherein the welding creates a weld in contact with an entirety of the beveled-surface.

15. An impeller hub, comprising:
an elongated member portion including an inner surface having a first end arranged to be in contact with an impeller assembly, wherein the elongated member portion further includes an outer surface having a second end arranged to not be in contact with the impeller assembly when the first end is in contact,
a beveled-surface arranged to extend axially and radially outward from the impeller assembly, during contact of the first end, from the first end of the inner surface to the second end of the outer surface.
